(19) United States
(12) Patent Application Publication
(10) Pub. No.: US 2026/0368862 A1
(43) Pub. Date: Nov. 19, 2026

(54) CHROMA ENHANCEMENT OF STREAMED COMPUTER IMAGERY

(71) Applicant: MICROSOFT TECHNOLOGY LICENSING, LLC, Redmond, WA (US)

(72) Inventors: Liran Lipa LYABOCK, Tel Aviv (IL); Sandeep PATNAIK, Kirkland, WA (US); Vadim MISHALOV, Tel Aviv (IL); Stefan Atanasov GEORGIEV, North Bend, WA (US); Dag Birger FROMMHOLD, Metzingen (DE); Julian Sebastian MEDER, Eningen (DE); Amir ZYSKIND, Herzella (IL)

(21) Appl. No.: 19/427,987

(22) Filed: Dec. 19, 2025

Related U.S. Application Data
(60) Provisional application No. 63/807,468, filed on May 16, 2025.

(51) Int. Cl. G06T 5/60; G06T 3/4046; G06T 3/4092; G06T 11/10; G06T 11/23

(52) U.S. Cl. CPC G06T 5/60; G06T 3/4046; G06T 3/4092; G06T 11/10; G06T 11/23; G06T 2200/16; G06T 2200/24; G06T 2207/20016; G06T 2207/20081; G06T 2207/20084; G06T 2210/36

(57) ABSTRACT

Improved techniques at a client for use with server-side rendering include receiving and decoding a compressed image to produce a chroma-reduced reconstructed image. A chroma enhancement system may apply an AI model system to the reconstructed image to create a chroma enhanced image which may then be presented on a display at the client.

### PRIORITY CLAIM

This application claims the benefit of and priority to U.S. Provisional Patent Application No. 63/807,468, filed May 16, 2025, the entire contents of which are incorporated herein by reference.

### BACKGROUND

Client-server computing systems spread computing tasks between a client and a server. Over time, the distribution of computing tasks has changed as, for example, the relative computational capabilities of a typical client and server have changed and as types of computational tasks have changed. In particular, image rendering tasks have moved back and forth between client and server over time.

In a typical example of client-side image rendering, a cloud computing service may include a cloud server with a cloud data store. A typical client device may access the data in the cloud data store via a network, and then locally render images at the client device based on data retrieved from the cloud data store. The locally rendered images may then be presented on a local client display.

In a typical example of server-side image rendering, a cloud computing service may render desktop imagery including user interface images, and then stream the rendered user interface images over a network to a client device, which may present the rendered user interface images on a local display. A client device used with server-side rendering is sometimes referred to as a “thin” client since the client device may perform relatively fewer computing tasks as compared to the client-side image rendering.

Modern cloud computing services may include complex graphics processing units (GPUs), which allow rendering of very complex computer graphics imagery without requiring an expensive and power-hungry GPU in every client device. However, a trade-off consequence of server-side image rendering can be the large bandwidth required to stream the rendered computer desktop imagery over the network connecting the thin client to the rendering server.

### SUMMARY

Improved techniques for server-side rendering include compressing chroma-reduced rendered images at the server, and streaming the compressed chroma-reduced rendered images to a client. Improved techniques at the client include using a neural network or other artificial intelligence (AI) model system to mitigate the visual artifacts created by chroma reduction at the server.

The improved techniques at the client include receiving and decoding a compressed image to produce a chroma-reduced reconstructed image. A chroma enhancement system may apply an AI model system to the chroma-reduced reconstructed image to create a chroma enhanced image which may then be presented on a display at a client device.

In some aspects, the improved techniques include upsampling chroma data and/or converting a color space of the chroma-reduced reconstructed image prior to enhancing chroma with the AI model system.

In another aspect, the AI model system may be trained by reducing chroma information of a training image such as by downsampling chroma components. Then the chroma-reduced training image may be chroma enhanced by applying the AI model system with a current set of model weights. The original training image may be compared to the chroma-enhanced version, and the current set of model weights may be updated based on the comparison.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 depicts an example client-server system with server-side rendering.

FIG. 2 depicts an example chroma enhancement system.

FIG. 3A depicts an example color corrector.

FIG. 3B depicts an example residual dense block (RDB) for color correction.

FIG. 4 depicts an example method for enhancing chroma at a client.

FIG. 5 depicts an example system for training a chroma enhancing AI model system.

FIG. 6 depicts an example method for training a chroma enhancing AI model system.

FIG. 7 depicts an example block diagram of a computing-based device that may be included in any of the above systems and may be used to implement any of the above methods.

### DETAILED DESCRIPTION

Server-side image rendering can reduce the complexity, cost, and power requirements for a client device, especially for applications that require a complex graphics processing unit (GPU) for rendering. Examples of such applications include an animated graphical user interface (GUI) or an animated video game which may render images with a high frame rate to produce smooth motion of objects in the images. This can result in high bandwidth requirements for streaming the images rendered at a server to a client device for display to a user. An image as used herein refers to any digital visual representation of graphical content, including but not limited to rendered frame(s) of a GUI or portions thereof, which may be encoded in various color formats and resolutions. Bandwidth requirements between client and server may be mitigated by reducing the amount of chroma information in the rendered images before streaming them to the client. Chroma information refers to the color-related components (e.g., hue, saturation) in an image. However, such chroma reduction may incur visual artifacts, such as color bleeding, visible bands, loss of fine detail, noise, and/or other artifacts. Such artifacts can be particularly problematic in typical computer desktop imagery depicting a GUI with sharp single-pixel color transitions along the stark straight lines that are commonly part of a graphical user interface and the sharp edges of rendered text. An artificial intelligence (AI) model system trained to correct color information in chroma-reduced desktop imagery may mitigate or even eliminate such visual artifacts and other deficiencies induced by the chroma information reduction. In some cases, the complexity, cost, and power requirements of image rendering (e.g., with a GPU) may be larger than the complexity, cost, and/or power requirements for a color enhancing AI model system such as a neural network. Hence, complexity, cost, and/or power requirements of a client device with a color enhancing system may be lower than the complexity, cost, and/or power requirement for a client device with a complex image rendering system.

Improved techniques for server-side rendering include compressing chroma-reduced rendered images at the server, and streaming the compressed images to a client. Improved techniques at the client include using an AI model system to mitigate the visual artifacts created by chroma reduction at the server.

The improved techniques at the client include receiving and decoding a compressed image to produce a chroma-reduced reconstructed image. A chroma enhancement system may apply an AI model system to the reconstructed image to create a chroma enhanced image which may then be presented on a display at the client.

In some aspects, the improved techniques include upsampling chroma information and/or converting a color space of the reconstructed image prior to enhancing chroma with the AI model system.

In another aspect, the AI model system may be trained by reducing chroma information of a training image, and then chroma enhancing the chroma-reduced training image using the AI model system with a current set of weights. The original training image may be compared to the chroma-enhanced version, and the current set of model weights may be updated based on the comparison.

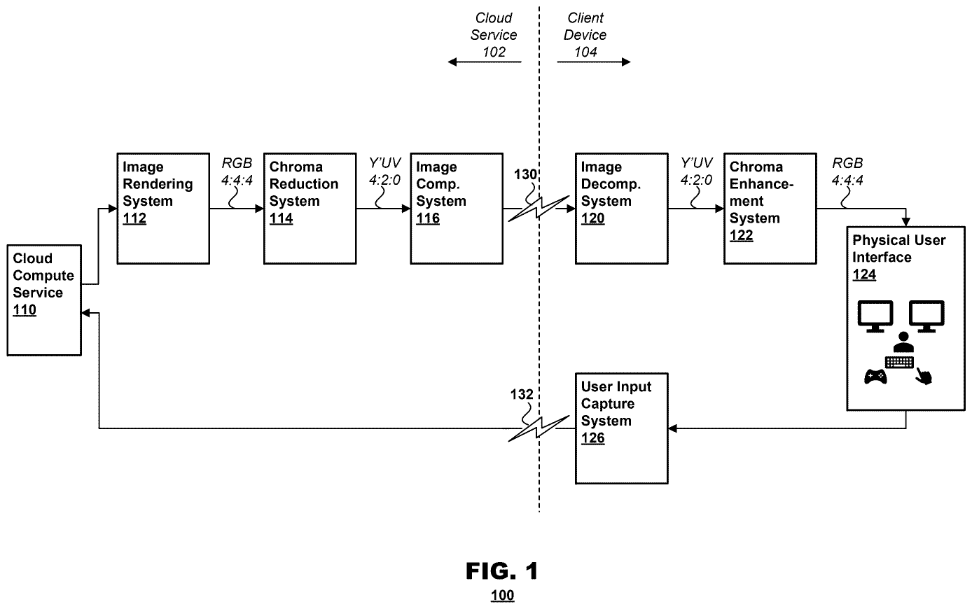

FIG. 1 depicts an example client-server system 100 with server-side rendering. Client-server system 100 includes a cloud service 102 and a client device 104 which are connected via networks 130, 132. In some embodiments, networks 130 and 132 may be the same network, which may be the internet, and in some embodiments, client device 104 may include one or more network interfaces (not depicted) for interfacing with network 130 and/or network 132. The client-server system 100 depicted in FIG. 1 provides an example context for implementations of a chroma enhancement system 122.

The cloud service 102 includes cloud compute service 110, image rendering system 112, chroma reduction system 114, and image compression system 116. Client device 104 includes image decompression system 120, chroma enhancement system 122, physical user interface 124, and user input capture system 126.

In operation, cloud compute service 110 may perform compute tasks for client device 104, for example as requested by a user of client device 104. Cloud compute service 110 may include one or more processors as well as transient and persistent storage. A visual user interface for the user of client device 104 may be created as a sequence of images by rendering system 112 at the cloud service 102. Image rendering system 112 may include, for example, a GPU to assist in the rendering. Chroma information in the rendered images may be reduced by chroma reduction system 114, for example by down sampling chroma components of pixel data in the images. The chroma-reduced images may be compressed by image compression system 116 for bandwidth-efficient transmission to client device 104 via network 130. Image compression system 116 may compress individual images or sequences of images according to, for example, still image or video compression standards such as the joint photographic experts group (JPEG), motion picture experts group (MPEG), high efficiency video coding (HEVC), and/or AOMedia Video 1 (AV1) standards.

A variety of image and pixel representations may be used within cloud service 102. One example set of representations (labeled in italics in FIG. 1) may include image rendering system 112 rendering in an RGB format, chroma reduction system 114 converting RGB images into a luma-chroma format (e.g., Y'UV or Y'CrCb) and then reducing the chroma information by downsampling the chroma components (e.g., U and V or Cr and Cb) to a lower resolution sampling pattern. For example, chroma reduction system 114 may perform both a color space conversion and a sampling pattern change, such as by converting RGB in a 4:4:4 full color resolution sampling pattern to Y'UV in a 4:2:0 reduced sampling pattern.

In operation, client device 104 may receive compressed rendered images from cloud service 102 via network 130. Image decompression system 120 may decompress the compressed rendered images into a chroma-reduced reconstruction of the original images rendered by image rendering system 112. The chroma-reduced reconstructed images may have reduced chroma information as compared to the original images. Chroma enhancement system 122 may mitigate visual artifacts created by the reduction in chroma information, for example by applying an AI model system trained on chroma-reduced desktop imagery. The resulting chroma-enhanced image may be presented or caused to be presented to a user of client device 102 on a display in the physical user interface 124 of client device 104.

As with cloud service 102, a variety of image and pixel representations may also be used within client device 104. One example set of representations (labeled in italics in FIG. 1) may include the image decompression system 120 producing a luma-chroma representation with reduced chroma information, such as Y'UV in a 4:2:0 reduced sampling pattern. Chroma enhancement system 122 may then produce images without reduced chroma, for example in an RGB format with 4:4:4 full color resolution sampling, which can then be used to present the image to a user on a display in the client device's physical user interface 124.

In an aspect of client-server system 100, client device 104 may capture user input and send that input to cloud service 102. For example, physical user interface 124 may include input devices such as, but not limited to, a keyboard, mouse, game controller, microphone, and/or a touch screen. Input from these devices may be captured by user input capture system 126 and relayed to cloud compute service 110 via network 132. In response to receiving the user input, cloud compute service 110 may cause image rendering system 112 to render new visual user interface images that are responsive to the received user input, and those new images may again be chroma reduced, compressed and sent to client device 104 for presentation to the user.

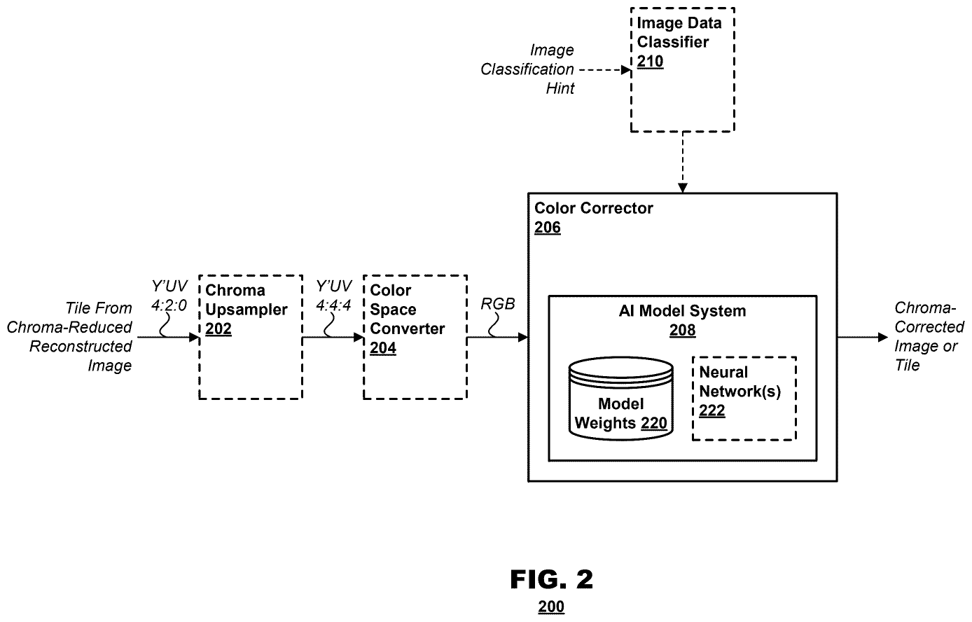

FIG. 2 depicts an example chroma enhancement system 200. Chroma enhancement system 200 may be an example implementation of chroma enhancement system 122 in FIG. 1. Chroma enhancement system 200 includes a color corrector 206 with an AI model system 208. AI model system 208 may include one or more models that may be controlled, at least in part, by model weights 220. AI model system 208 may include but is not limited to single models, multimodal models, systems of models, chains of models, or other combinations of models operable to accept a chroma-reduced image data and produce chroma-corrected and/or-enhanced image data. For example, AI model system 208 may include one or more neural networks 222 and/or other types of machine learning models.

In operation, color corrector 206 may accept images (or tiles of images) with reduced chroma information, such as an image reconstructed by image decompression system 120 (FIG. 1). In an aspect, color corrector 206 may operate on a portion of a reconstructed image at a time, for example by operating on a series of 240×128 pixel tiles of a 2560×1440 pixel (i.e., QHD resolution) reconstructed image. By operating on tile sub-portions of an image, a computational complexity of color corrector 206 may be reduced as compared to operating on full-sized images. Color corrector 206 may apply AI model system 208 to each image or portion thereof to produce a color-corrected image (or portion thereof). The produced color-corrected image may then be output by chroma enhancement system 200 as a chroma-enhanced image.

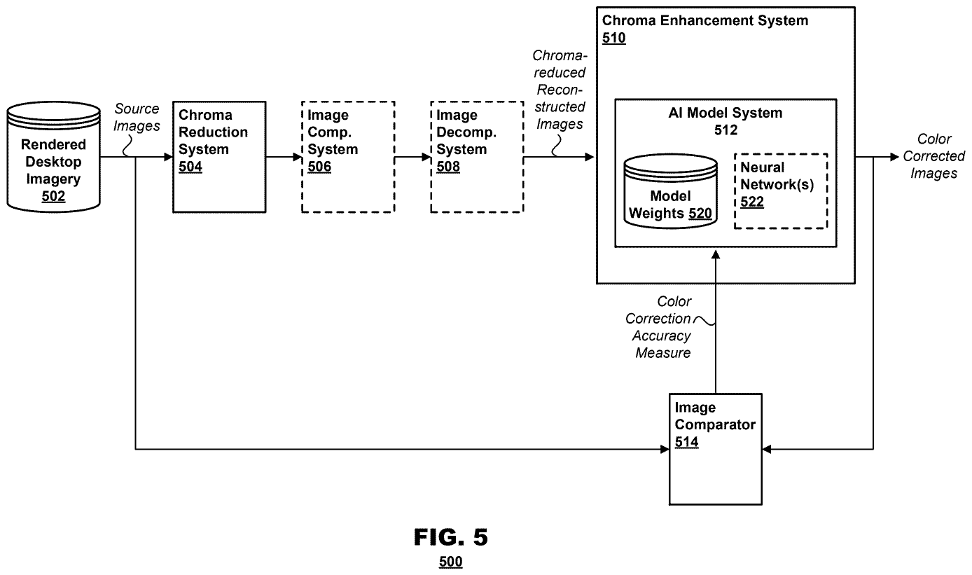

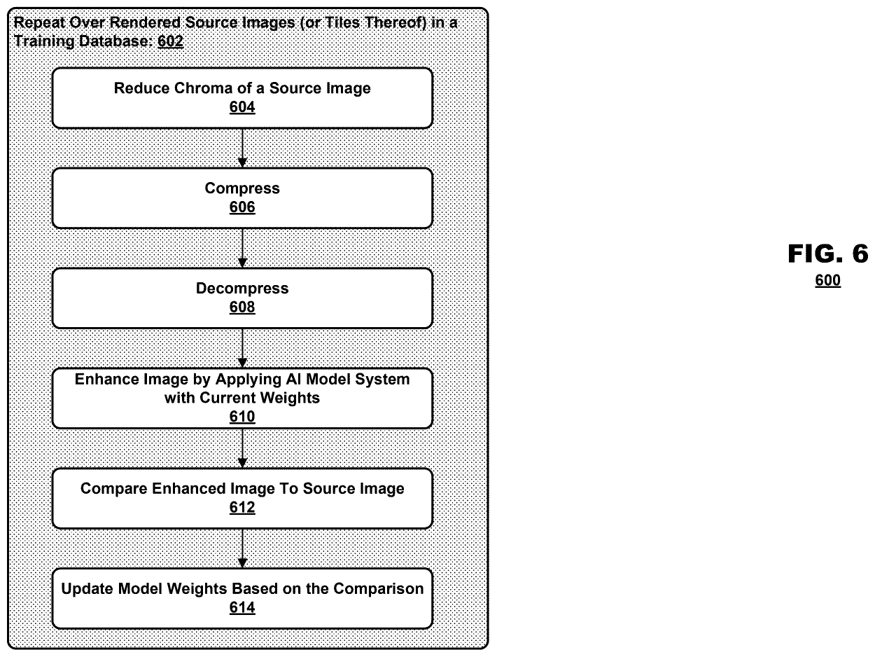

In aspects, AI model system 208 may include one or more convolutional neural networks (CNNs) or convolutional deep neural networks (CDNNs), and AI model system 208 may include residual dense block operators (RDBs). Furthermore, AI model system 208 may include a set of model weights 220 trained to mitigate visual artifacts induced by a reduction in (e.g., subsampling of) chroma information. For example, AI model system 208 may be trained on a database of training images that include typical computer desktop imagery, using a training system such as the one depicted in FIG. 5 using a training method such as the one depicted in FIG. 6. While AI model system 208 is depicted as a part of color corrector 206, in some embodiments, it may be implemented as a separate or hybrid component. For example, AI model system 208 may be implemented as a local element of client 104 (FIG. 1), implemented as a cloud service, or as a hybrid combination of local element and cloud service.

In some optional aspects, chroma enhancement system 200 may include a chroma upsampler 202 and/or color space converter 204. For example, as indicated in italics in FIG. 2, a chroma-reduced reconstructed image tile may be input to chroma enhancement system 200 in a Y'UV color space with 4:2:0 subsampled chroma channels. Chroma upsampler 202 may upsample the subsampled chroma channels to produce Y'UV 4:4:4, and then color space converter 204 may convert Y'UV 4:4:4 from the luma-chroma representation to an RGB representation. In an example implementation, chroma upsampler 202 may convert a chroma subsampled 4:2:0 Y'UV image tile into a 4:4:4 Y'UV image tile using Lanczos interpolation on the chroma components of the 4:2:0 image or one or more other types of image interpolation. Color corrector 206 may then operate on three RGB channels of equal resolution. In another example, color corrector 206 may operate directly on a 4:4:4 upsampled luma-chroma representation, and color space conversion to an RGB format may occur after color correction by color corrector 206. In a third example, color corrector 206 may operate directly on a chroma subsampled format, such as Y'UV 4:2:0, and produce either a Y'UV 4:4:4 output or an RGB 4:4:4 output.

In another optional aspect, color corrector 206 may correct the color of an image based on a classification of the image's content. Optional image data classifier 210 may identify and/or categorize images based on their visual content. Image data classifier 210 may take an image (or portion thereof) as input and then output a label or category that best describes the image's content. For example, image data classifier 210 may provide classifications indicating which portions of the image are more like typical computer desktop imagery (e.g., with text and lines with single-pixel-wide transitions) and which portions are atypical of computer desktop imagery (e.g., a real-life scene as captured by a camera or images without single-pixel-wide transitions). Images with typical computer desktop imagery may be more susceptible to human visual system detection of chroma-reduction artifacts while images of real-life scenes may be less susceptible to detection of chroma-reduction artifacts. In one aspect, image data classifier 210 may classify an image by analyzing the pixel content of the image with a classifying AI model system. Alternately or additionally, image data classifier 210 may classify an image based on an image classification hint received along with the image from cloud service 102 (FIG. 1). An image classification hint may be any information that suggests a classification of image data content. An image classification hint from the cloud service 102 may be based, for example, on an image content classification process applied to the images within the cloud service 102. For example, a photos collection application may provide a hint that the portion of a GUI image depicting a natural photo likely includes natural photo content and therefore likely includes few visual artifacts caused by a reduction in chroma information. In another example, a computer spreadsheet application may provide a hint that a portion of a GUI image depicting a computer spreadsheet is typical desktop imagery that likely includes stark line transitions and therefore may include more relatively many visual artifacts caused by a reduction in chroma information.

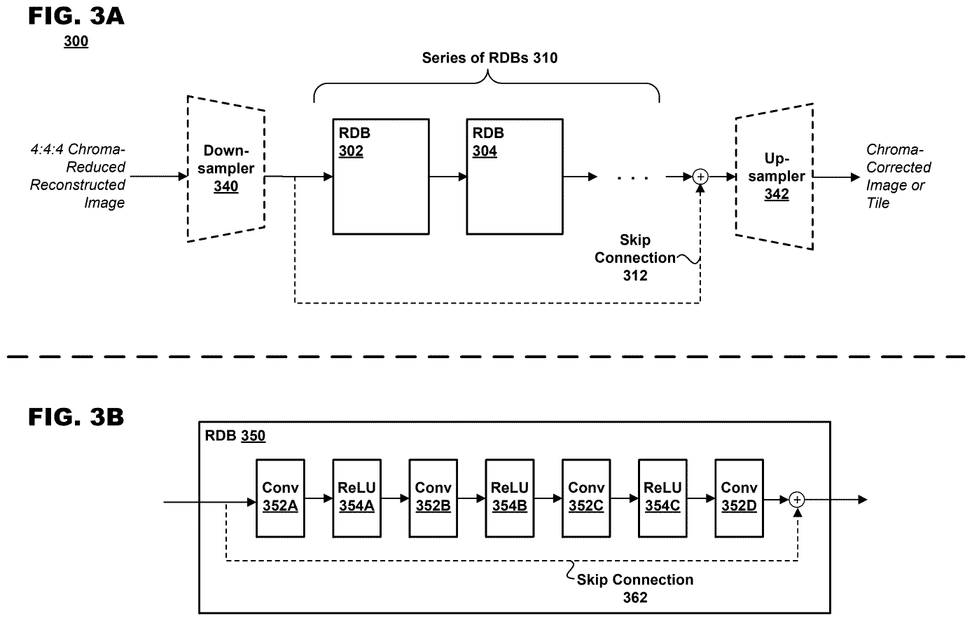

FIG. 3A depicts an example color corrector 300. Color corrector 300 may be an example of color corrector 206 (FIG. 2). Color corrector 300 includes a series of residual dense blocks (RDBs) 310. The series of RDBs 310 includes two or more RDBs, such as RDB 302 and RDB 304 depicted in the example of FIG. 3A. Each RDB in the series of RDBs 310 are connected serially, with the input of each subsequent RDB connected to the output of a prior RDB such that the output of the prior RDB is used as the input for the subsequent RDB. For example, in FIG. 3A, RDB 302 is the initial RDB and RDB 304 is subsequent to RDB 302 with the input of RDB 304 connected to the output of RDB 302. Each RDB in the series of RDBs 310 may include a portion of AI model system 208 and each RDB in the series of RDBs 310 may include a subset of model weights 220. An example RDB is described below regarding FIG. 3B.

In operation of an example, color corrector 300 takes a 4:4:4 version of a chroma reduced image (or tile of an image) as input. For example, the Y'UV 4:4:4 output of chroma upsampler 202 (FIG. 2) or the RGB output of color space converter 204 (FIG. 2) may be used as input to color corrector 300. The series of RDBs 310 may implement an AI model system for predicting and/or correcting errors due to a subsampling of chroma information.

FIG. 3A also depicts optional elements including downsampler 340, upsampler 342, and skip connection 312. In some aspects, downsampler 340 and upsampler 342 may reduce a computational complexity of color corrector 300 by reducing the spatial dimensions of images processed by series of RDBs 310, and hence reducing the amount of data processed per image by series of RDBs 310. The amount of processing performed by RDBs may be a significant computational burden on a client device (such as client device 104 of FIG. 1), and optional downsampler 340 may be included with a paired upsampler 342 in order to reduce this computational burden. In an aspect, downsampler 340 may be a convolutional downsampler and upsampler 342 may be a convolutional upsampler

Skip connection 312 provides a data path that bypasses the series of RDBs 310, taking the images input to the series of RDBs 310 and adding them to the output of the series of RDBs 310. In an aspect, the series of RDBs 310 predicts a “residual” missing from the input to the series of RDBs 310, and the skip connection 312 adds the input of the series of RDBs 310 to “residual” output of the series 310.

FIG. 3B depicts an example residual dense block (RDB) 350 for color correction. RDB 350 may be an example implementation of RDBs 302 and 304 of FIG. 3A. In aspects, an RDB may include a sequence of convolutional layers interleaved with a sequence of activation layers such as rectified linear units (ReLUs). In the example of FIG. 3B, convolutional unit operators 352A, 352B, 352C, and 352D are interleaved with ReLU operators 354A, 354B, and 354C to create a single series of interleaved operators in RDB 350. In this series of operators, an output of a prior operator may be used as an input to the subsequent operator. For example, the output of convolution operator 352A may be used as input to ReLU 354A, and then the output of ReLU 354A may be used as an input to convolutional operator 354B, which then produces an output that may be used as input to ReLU 354B, and so forth through the end of the series of operators in RDB 350. RDB 350 may also include an optional skip connection 362 that bypasses the series operators, taking the images input to the series of operators and adding them to the output of the series of operators, similar to the way skip connection 312 bypasses the series of RDBs 310 in FIG. 3A.

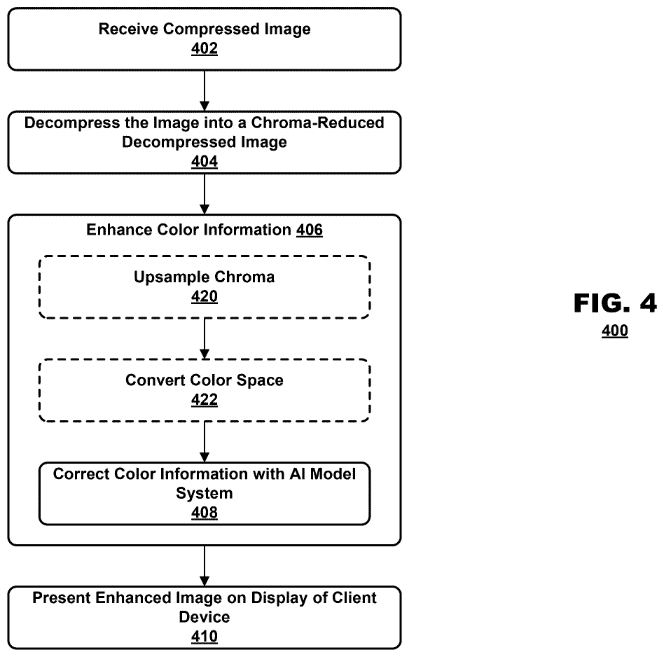

FIG. 4 depicts a method 400 for enhancing chroma at a client. Method 400 may be performed, for example, by client device 104 (FIG. 1). Method 400 includes receiving a compressed image (box 402). The compressed image may be received, for example, from a server or cloud service via network. In an aspect, the compressed image may be received as a compressed video including a sequence of images. The received compressed image may then be decompressed into a chroma-reduced decompressed image (box 404). Color information of the decompressed image may be enhanced (box 406), including color correcting the decompressed image using an AI model system (box 408), where model weights of the AI model system may be trained, for example, to reduce visual artifacts caused by a reduction in chroma information in computer desktop imagery. The resultant color enhanced image may then be presented to a user on a display of a client device (box 410).

In some optional aspects of method 400, enhancing color information (box 406) may include upsampling chroma (box 420) and/or converting a color space (box 422). As depicted in FIGS. 2 and 4, chroma upsampling and color converting may occur prior to correcting color information (e.g. at an input to color corrector 206). In one alternative, a color space converter may optionally be applied to the result of color correction (e.g. at an output of color corrector 206). In another alternative, chroma upsampling and/or color space conversion may occur as a by-product of correcting color information (e.g., chroma upsampling and/or color space conversion may occur within color corrector 206).

FIG. 5 depicts a system 500 for training a chroma enhancing AI model system. System 500 may be used, for example, to train the model weights 220 of AI model system 208. System 500 includes rendered desktop imagery database 502, chroma reduction system 504, chroma enhancement system 510 with AI model system 512, and image comparator 514. AI model system 208 and AI model system 512 may be similar or identical to each other, and after training model weights 520 with training system 500, model weights 520 may be used as model weights 220 in AI model system 208 (FIG. 1).

AI model system 512 may include one or more models that may be controlled, at least in part, by model weights 520. AI model system 512 may include but is not limited to single models, multimodal models, systems of models, chains of models, or other combinations of models operable accept a chroma-reduced image data and produce chroma-corrected image data. For example, AI model system 512 may include one or more neural networks 522 and/or other types of machine learning models.

In operation, source images from the rendered desktop imagery database 502 may serve as training data for AI model system 512. Chroma reduction system 504 may reduce the chroma information in the source training images from the database 502 to produce chroma-reduced images. Chroma enhancement system 510 may enhance the chroma information in the chroma-reduced training images by applying AI model system 512 with a current set of weights to produce a color corrected image. The effectiveness of the color correction by chroma enhancement system 510 may be measured by comparing the color corrected image to its corresponding source training image by image comparator 514 to produce a color correction accuracy measure. The color correction accuracy measure may then be used to adjust the current model weights.

In an aspect, training system 500 may operate on a single tile (or another subset of an image) from the rendered desktop imagery database 502. In this aspect, chroma reduction system 504, chroma enhancement system 510, and image comparator 514 may all operate on one tile at a time, sequencing through a series of tiles for each training image from the rendered desktop imagery database 502.

In an optional aspect, training AI model system 512 may additionally include training on compression artifacts caused by compressing and decompressing the chroma-reduced image. A chroma reduced image produced by chroma reduction system 504 may be compressed by optional image compression system 506 to produce a compressed image which is then decompressed by optional image decompression system 508 to produce a reconstructed version of the chroma reduced image. The chroma-reduced reconstructed image may include visual artifacts due to both the chroma information reduction and a lossy image compression process. In this aspect, chroma enhancement system 510 will attempt to color correct an image that includes additional lossy compression artifacts that will generally be present in compressed images received at client device 104 from cloud service 102 (FIG. 1).

In example implementations, rendered desktop imagery may include various images of a computer desktop or GUI, and may include stark transitions in color, such as single-pixel-wide lines and rendered text. Chroma reduction system 504 may be similar to chroma reduction system 114 (FIG. 1), optional image compression system 506 may be similar to image compression system 116 (FIG. 1), optional image decompression system 508 may be similar to image decompression system 120 (FIG. 1), chroma enhancement system 510 may be similar to chroma enhancement system 122 (FIG. 1), AI model system 512 may be similar to AI model system 208 (FIG. 2), and AI model weights trained with training system 500 may be used by AI model system 208 (FIG. 2).

FIG. 6 depicts a method 600 for training a chroma enhancing AI model system. Method 600 may be implemented, for example, on system 500 (FIG. 5). Method 600 includes repeating for rendered source images in a training database (box 602): reduce chroma information from a source training image (box 604); compress the reduced-chroma image (box 606); and decompress the compressed image (box 608) to produce a reconstructed reduced-chroma training image. The reconstructed training image may then be enhanced by applying an AI model system using a current set of model weights (box 610) to produce an enhanced image. The enhanced image is then compared to its corresponding source training image from the training database (box 612), and the set of current model weights may be updated based on the comparison of images (box 614).

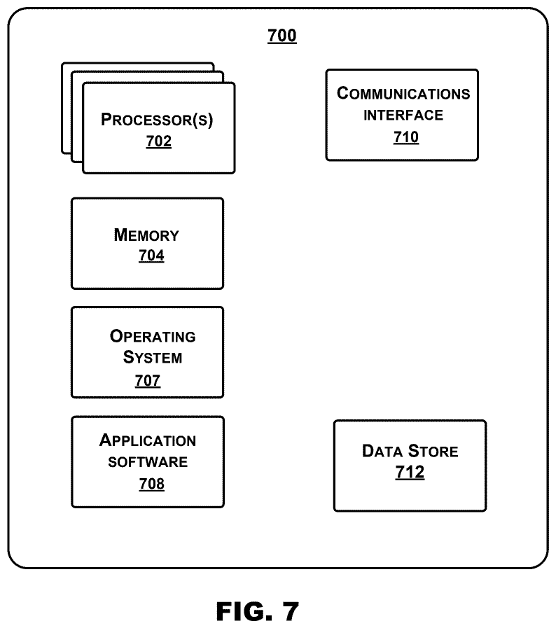

FIG. 7 depicts a block diagram of a computing-based device 700 that may be included in any of the above systems and may be used to implement any of the above methods. FIG. 7 illustrates various components of an example computing-based device 700 which are implemented as any form of a computing and/or electronic device. In some examples, computing-based device 700 is a general-purpose computer that is activated or reconfigured by a computer program stored in the computer. In other examples, computing-based device 700 is specially constructed for the intended purpose. In some examples, computing device 700 is a microprocessor used in embedded systems applications or other suitable applications. Processor(s) 702 may be employed as examples of (or an example component of) cloud service 102 or client device 104 (FIG. 1), chroma enhancement system 200 (FIG. 2), and/or system 500 for training a chroma enhancing AI model system (FIG. 5). Processor(s) 702 may be used to implement some or all of method 400 (FIG. 4) and/or method 600 (FIG. 6).

Computing-based device 700 comprises one or more processors 702 which are microprocessors, controllers, or any other suitable type of processors for processing computer executable instructions to control the operation of the device. The processor(s) 702 may include at least one general-purpose processing device such as a central processing unit, microprocessor, complex instruction set computing (CISC) microprocessor, reduced instruction set computing (RISC) microprocessor, or other general-purpose processing device. In some examples, for example where a system on a chip architecture is used, the processors 702 include one or more special-purpose processing device such as a fixed function block. The special-purpose processing device may be configured to execute instructions for performing the operations and methods described herein. Platform software comprising an operating system 706 or any other suitable platform software is provided at the computing-based device to enable application software 708 to be executed on the device. Data store 712 holds system prompts, context, bot code and other data.

The computer executable instructions are provided using any computer-readable media or storage device that is accessible by computing-based device 700. Computer-readable media includes, for example, computer storage media such as memory 704 and communications media. Computer storage media, such as memory 704, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device.

In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 704) is shown within the computing-based device 700 it will be appreciated that the storage is, in some examples, distributed or located remotely and accessed via a network or other communication link (e.g., using communication interface 710). The computing-based device is able to communicate with other bots and communications network nodes via communications interface 710.

The disclosure presented herein also encompasses the subject matter set forth in the following clauses:

Clause 1: A method for enhancing color information of computer desktop imagery, the method comprising:
receiving, via a network at a client device, a compressed image;
decompressing the compressed image to produce a decompressed image having subsampled chroma data;
enhancing chroma data of the decompressed image to produce an enhanced image having an RGB color space, the enhancing including applying an artificial intelligence (AI) model system to the decompressed image, wherein the AI model system includes weights trained to correct chroma sampling deficiencies in computer desktop imagery; and
presenting the enhanced image on a display of the client device.

Clause 2: The method of clause 1, wherein the decompressed image includes luma data and the subsampled chroma data, and the enhancing of the chroma data includes:
upsampling the subsampled chroma data to produce upsampled chroma data;
enhancing the upsampled chroma data based on the luma data and the AI model system to produce the enhanced image having the RGB color space.

Clause 3: The method of clause 1, wherein the decompressed image includes luma data and the subsampled chroma data, and the enhancing of the chroma data includes:
converting a color space of the decompressed image from a luma-chroma color space to the RGB color space;
enhancing the chroma data of the decompressed image in the RGB color space to produce the enhanced image.

Clause 4: The method of clause 1, wherein the computer desktop imagery includes rendered text.

Clause 5: The method of clause 1, wherein the AI model system includes a convolutional neural network with two or more residual dense block operators (RDBs) connected in series.

Clause 6: The method of clause 1, further comprising:
capturing user input from a physical user interface of the client device;
sending the user input from the client device to a cloud service via a computer network;
in response to the sending of the user input to the cloud service, receiving a second compressed image based on the user input.

Clause 7: The method of clause 1, further comprising:
training the weights for the AI model system, wherein the training comprises, for an original training image from a database of the computer desktop imagery:
applying a chroma reduction system to the original training image to produce a reduced-chroma training image;
compressing the reduced-chroma training image;
decompressing the compressed training image;
enhancing the chroma data of the decompressed training image with the AI model system using current weights to produce an enhanced training image;
comparing the enhanced training image with the original training image;
updating the current weights based on the comparison.

Clause 8: A client device comprising:
a network interface;
an image decompression system;
a chroma enhancement system including an AI model system;
a display; and
a processor and memory storing instructions that, when executed by the processor, cause the client device to:
receive, via the network interface, a compressed image;
decompress, by the image decompression system, the compressed image to produce a decompressed image having subsampled chroma data;
enhance, by the chroma enhancement system, chroma data of the decompressed image to produce an enhanced image having an RGB color space, the enhancing including applying the AI model system to the decompressed image, wherein the AI model system includes weights trained to correct chroma sampling deficiencies in computer desktop imagery; and
present the enhanced image on the display of the client device.

Clause 9: The client device of clause 8, wherein the decompressed image includes luma data and the subsampled chroma data, and the enhancing of the chroma data includes:
upsample the subsampled chroma data to produce upsampled chroma data;
enhance the upsampled chroma data based on the luma data and the AI model system to produce the enhanced image having the RGB color space.

Clause 10: The client device of clause 8, wherein the decompressed image includes luma data and the subsampled chroma data, and the enhancing of the chroma data includes:
convert a color space of the decompressed image from a luma-chroma color space to the RGB color space;
enhance the chroma data of the decompressed image in the RGB color space to produce the enhanced image.

Clause 11: The client device of clause 8, wherein the computer desktop imagery includes rendered text.

Clause 12: The client device of clause 8, wherein the AI model system includes a convolutional neural network with two or more residual dense block operators (RDBs) connected in series.

Clause 13: The client device of clause 8, wherein the instructions further cause the client device to:
capture user input from a physical user interface of a client device;
send the user input from the client device to a cloud service via a computer network;
in response to the sending of the user input to the cloud service, receive a second compressed image based on the user input.

Clause 14: The client device of clause 8, wherein the instructions further cause the client device to:
train the weights for the AI model system, wherein the training comprises, for an original training image from a database of the computer desktop imagery:
apply a chroma reduction system to the original training image to produce a reduced-chroma training image;
compress the reduced-chroma training image;
decompress the compressed training image;
enhance the chroma data of the decompressed training image with the AI model system using current weights to produce an enhanced training image;
compare the enhanced training image with the original training image;
update the current weights based on the comparison.

Clause 15: A computer-readable storage device storing instructions that, when executed on one or more processors of a client device, cause the client device to:
receive, via a network at a client device, a compressed image;
decompress the compressed image to produce a decompressed image having subsampled chroma data;
enhance chroma data of the decompressed image to produce an enhanced image having an RGB color space, the enhancing including applying an AI model system to the decompressed image, wherein the AI model system includes weights trained to correct chroma sampling deficiencies in computer desktop imagery;
present the enhanced image on a display of the client device.

Clause 16: The computer-readable storage device of clause 15, wherein the decompressed image includes luma data and the subsampled chroma data, and the enhancing of the chroma data includes:
upsample the subsampled chroma data to produce upsampled chroma data;
enhance the upsampled chroma data based on the luma data and the AI model system to produce the enhanced image having the RGB color space.

Clause 17: The computer-readable storage device of clause 15, wherein the decompressed image includes luma data and the subsampled chroma data, and the enhancing of the chroma data includes:
convert a color space of the decompressed image from a luma-chroma color space to the RGB color space;
enhance the chroma data of the decompressed image in the RGB color space to produce the enhanced image.

Clause 18: The computer-readable storage device of clause 15, wherein the computer desktop imagery includes rendered text.

Clause 19: The computer-readable storage device of clause 15, wherein the AI model system includes a convolutional neural network with two or more residual dense block operators (RDBs) connected in series.

Clause 20: The computer-readable storage device of clause 15, wherein the instructions further cause the client device to:
capture user input from a physical user interface of a client device;
send the user input from the client device to a cloud service via a computer network;
in response to the sending of the user input to the cloud service, receive a second compressed image based on the user input.

In the above detailed description, reference is made to the accompanied drawings, which form a part hereof, and which is shown by way of illustration, specific example configurations of which the concepts can be practiced. These configurations are described in sufficient detail to enable those skilled in the art to practice the techniques disclosed herein, and it is to be understood that other configurations can be utilized, and other changes may be made, without departing from the spirit or scope of the presented concepts. The above detailed description is, therefore, not to be taken in a limiting sense, and the scope of the presented concepts is defined only by the appended claims.

The above description provides specific details for a thorough understanding of, and enabling description for, various examples of the technology. One skilled in the art will understand that the technology may be practiced without many of these details. In some instances, well-known structures and functions have not been shown or described in detail to avoid unnecessarily obscuring the description of examples of the technology. It is intended that the terminology used in this disclosure be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section. Throughout the specification and claims, the following terms take at least the meanings explicitly associated herein, unless the context dictates otherwise. The meanings identified below do not necessarily limit the terms, but merely provide illustrative examples for the terms. For example, each of the terms “based on” and “based upon” is not exclusive, and is equivalent to the term “based, at least in part, on,” and includes the option of being based on additional factors, some of which may not be described herein. As another example, the term “via” is not exclusive, and is equivalent to the term “via, at least in part,” and includes the option of being via additional factors, some of which may not be described herein. The phrase “in one example,” as used herein does not necessarily refer to the same embodiment or example, although it may. Use of particular textual numeric designators does not imply the existence of lesser-valued numerical designators. References in the singular are made merely for clarity of reading and include plural references unless plural references are specifically excluded. The term “or” is an inclusive “or” operator unless specifically indicated otherwise. For example, the phrase “A or B” means “A, B, or A and B.” As used herein, the terms “component” and “system” are intended to encompass hardware, software, or various combinations of hardware and software. Thus, for example, a system or component may be a process, a process executing on a computing device, the computing device, or a portion thereof. The meaning of “a,” “an,” and “the” includes plural reference, and the meaning of “in” includes “in” and “on.” The term “connected” means a direct electrical connection between the items connected, without any intermediate devices. The term “coupled” means a direct electrical connection between the items connected, or an indirect connection through one or more passive or active intermediary devices and/or components. The term “signal” means at least a power, current, voltage, data, electric wave, magnetic wave, electromagnetic wave, or optical signal. Based upon context, the term “coupled” may refer to a wave or field coupling effect, which may relate to a corresponding optical field, magnetic field, electrical field, or a combined electromagnetic field.

It will be understood that the configurations and/or approaches described herein are examples, and that these specific embodiments or examples are not to be considered in a limiting sense, because numerous variations are possible. As such, various systems, circuits, and/or devices may be broken into additional functions or circuits, and/or combined with other functions or circuits as may be desirable in a specific implementation. Similarly, the specific routines, procedures or methods described herein may represent one or more of any number of processing strategies. As such, various acts illustrated and/or described may be performed in the sequence illustrated and/or described, in other sequences, in parallel, or omitted. Likewise, the order of the above-described processes or methods may be changed. The subject matter thus includes all novel and non-obvious combinations and sub-combinations of the methods, processes, circuits, devices, systems and configurations, and other features, functions and/or properties disclosed herein, as well as any and all equivalents thereof.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method for enhancing color information of computer desktop imagery, the method comprising:
receiving, via a network at a client device, a compressed image;
decompressing the compressed image to produce a decompressed image having subsampled chroma data;
enhancing chroma data of the decompressed image to produce an enhanced image having an RGB color space, the enhancing including applying an artificial intelligence (AI) model system to the decompressed image, wherein the AI model system includes weights trained to correct chroma sampling deficiencies in computer desktop imagery; and
presenting the enhanced image on a display of the client device.

2. The method of claim 1, wherein the decompressed image includes luma data and the subsampled chroma data, and the enhancing of the chroma data includes:
upsampling the subsampled chroma data to produce upsampled chroma data;
enhancing the upsampled chroma data based on the luma data and the AI model system to produce the enhanced image having the RGB color space.

3. The method of claim 1, wherein the decompressed image includes luma data and the subsampled chroma data, and the enhancing of the chroma data includes:
converting a color space of the decompressed image from a luma-chroma color space to the RGB color space;
enhancing the chroma data of the decompressed image in the RGB color space to produce the enhanced image.

4. The method of claim 1, wherein the computer desktop imagery includes rendered text.

5. The method of claim 1, wherein the AI model system includes a convolutional neural network with two or more residual dense block operators (RDBs) connected in series.

6. The method of claim 1, further comprising:
capturing user input from a physical user interface of the client device;
sending the user input from the client device to a cloud service via a computer network;
in response to the sending of the user input to the cloud service, receiving a second compressed image based on the user input.

7. The method of claim 1, further comprising:
training the weights for the AI model system, wherein the training comprises, for an original training image from a database of the computer desktop imagery:
applying a chroma reduction system to the original training image to produce a reduced-chroma training image;
compressing the reduced-chroma training image;
decompressing the compressed training image;
enhancing the chroma data of the decompressed training image with the AI model system using current weights to produce an enhanced training image;
comparing the enhanced training image with the original training image;
updating the current weights based on the comparison.

8. A client device comprising:
a network interface;
an image decompression system;
a chroma enhancement system including an AI model system;
a display; and
a processor and memory storing instructions that, when executed by the processor, cause the client device to:
receive, via the network interface, a compressed image;
decompress, by the image decompression system, the compressed image to produce a decompressed image having subsampled chroma data;
enhance, by the chroma enhancement system, chroma data of the decompressed image to produce an enhanced image having an RGB color space, the enhancing including applying the AI model system to the decompressed image, wherein the AI model system includes weights trained to correct chroma sampling deficiencies in computer desktop imagery; and
present the enhanced image on the display of the client device.

9. The client device of claim 8, wherein the decompressed image includes luma data and the subsampled chroma data, and the enhancing of the chroma data includes:
upsample the subsampled chroma data to produce upsampled chroma data;
enhance the upsampled chroma data based on the luma data and the AI model system to produce the enhanced image having the RGB color space.

10. The client device of claim 8, wherein the decompressed image includes luma data and the subsampled chroma data, and the enhancing of the chroma data includes:
convert a color space of the decompressed image from a luma-chroma color space to the RGB color space;
enhance the chroma data of the decompressed image in the RGB color space to produce the enhanced image.

11. The client device of claim 8, wherein the computer desktop imagery includes rendered text.

12. The client device of claim 8, wherein the AI model system includes a convolutional neural network with two or more residual dense block operators (RDBs) connected in series.

13. The client device of claim 8, wherein the instructions further cause the client device to:
capture user input from a physical user interface of a client device;
send the user input from the client device to a cloud service via a computer network;
in response to the sending of the user input to the cloud service, receive a second compressed image based on the user input.

14. The client device of claim 8, wherein the instructions further cause the client device to:
train the weights for the AI model system, wherein the training comprises, for an original training image from a database of the computer desktop imagery:
apply a chroma reduction system to the original training image to produce a reduced-chroma training image;
compress the reduced-chroma training image;
decompress the compressed training image;
enhance the chroma data of the decompressed training image with the AI model system using current weights to produce an enhanced training image;
compare the enhanced training image with the original training image;
update the current weights based on the comparison.

15. A computer-readable storage device storing instructions that, when executed on one or more processors of a client device, cause the client device to:
receive, via a network at a client device, a compressed image;
decompress the compressed image to produce a decompressed image having subsampled chroma data;
enhance chroma data of the decompressed image to produce an enhanced image having an RGB color space, the enhancing including applying an AI model system to the decompressed image, wherein the AI model system includes weights trained to correct chroma sampling deficiencies in computer desktop imagery;
present the enhanced image on a display of the client device.

16. The computer-readable storage device of claim 15, wherein the decompressed image includes luma data and the subsampled chroma data, and the enhancing of the chroma data includes:
upsample the subsampled chroma data to produce upsampled chroma data;
enhance the upsampled chroma data based on the luma data and the AI model system to produce the enhanced image having the RGB color space.

17. The computer-readable storage device of claim 15, wherein the decompressed image includes luma data and the subsampled chroma data, and the enhancing of the chroma data includes:
convert a color space of the decompressed image from a luma-chroma color space to the RGB color space;
enhance the chroma data of the decompressed image in the RGB color space to produce the enhanced image.

18. The computer-readable storage device of claim 15, wherein the computer desktop imagery includes rendered text.

19. The computer-readable storage device of claim 15, wherein the AI model system includes a convolutional neural network with two or more residual dense block operators (RDBs) connected in series.

20. The computer-readable storage device of claim 15, wherein the instructions further cause the client device to:
capture user input from a physical user interface of a client device;
send the user input from the client device to a cloud service via a computer network;
in response to the sending of the user input to the cloud service, receive a second compressed image based on the user input.
